(19) United States
(12) Patent Application Publication
(10) Pub. No.: US 2024/0286522 A1
(43) Pub. Date: Aug. 29, 2024

(54) ARRANGEMENT AND METHOD FOR DATA MANAGEMENT DURING CHARGING EVENT, AND COMPUTER PROGRAM PRODUCT

(71) Applicant: Kempower Oyj, Lahti (FI)

(72) Inventor: Juhana ENQVIST, Lahti (FI)

(21) Appl. No.: 18/693,073

(22) PCT Filed: Sep. 21, 2022
(86) PCT No.: PCT/FI2022/050634

§ 371 Date: Mar. 18, 2024

(30) Foreign Application Priority Data
Sep. 29, 2021 (FI) 20216007
Jul. 26, 2022 (FI) 20225687

(51) Int. Cl. B60L 53/68

(52) U.S. Cl. CPC B60L 53/68

(57) ABSTRACT

An information delivery arrangement (1) and a method for data management during a charging event of an electric vehicle (2) is provided. The arrangement comprises at least one charging point (3), a display element (36) and at least one control unit (6). The at least one control unit identifies an ongoing charging event, receives charging event data related to at least one of the charging event and the electric vehicle (2) being charged during on ongoing charging event, and receives at least one piece of additional data. The at least one control unit (6) generates output data based on at least the charging event data and the received additional data, and causes the display element to display the output data during the charging event.

### BACKGROUND

The present disclosure relates to generating and delivering information, especially generating and delivering relevant data at a relevant time, in connection with charging events of electric vehicles, and more particularly to arrangement and method for data management in connection with a charging event. The present disclosure further concerns a computer program product.

Nowadays, people are exposed to marketing communications almost everywhere, also at gas and charging stations. Internet marketing has developed to be very targeted; people receive advertisements and other types of marketing communications about products and services they have searched in internet search tools. However, this does not apply to marketing communications distributed through for instance shopping mall display boards or displays at gas station displays. These advertisements are, at best, selected based on the location, such as marketing the shops at the mall, or the season, such as showing winter tyre advertisements in September.

Marketing communications that reach consumers at a wrong time, in a wrong place or reach wrong consumers altogether, are only costs with no benefits for either the seller or the consumer.

### BRIEF DESCRIPTION OF THE DISCLOSURE

An object of the present disclosure is to provide a new method and a new arrangement for data management during a charging event, and a new computer program product.

The object of the disclosure is achieved by a method and an arrangement which are characterized by what is stated in the independent claims. Some embodiments of the disclosure are disclosed in the dependent claims.

The disclosure is based on the idea of collecting, processing and displaying information during a charging event.

According to a first aspect, an information delivery arrangement for data management during a charging event is provided. The information delivery arrangement comprises at least one charging point configured to be connected to one electric vehicle, at a time for charging the electric vehicle during a charging event. The information also comprises a display element, and at least one control unit. The control unit is configured to identify an ongoing charging event, to receive charging event data related to at least one of the charging event and the electric vehicle being charged during the charging event, and to receive at least one piece of additional data. The control unit is further configured to generate output data based on at least the charging event data and the received additional data, and to display the output data on the display element during the charging event.

According to embodiments, the control unit is configured to use at least the charging event data and the additional data as parameters when generating the output data by comparing these parameters to predetermined conditions.

According to some embodiments, the additional data comprises at least one of the following: an estimated duration of the charging event, a location of the charging point, a location of the charging point in relation to a service provider, a distance of the charging point to a service provider, time, date, day of the week, time of the year, weather information, road weather, road traffic congestion data, predetermined destination of the electric vehicle, predetermined route of the electric vehicle, remaining distance to the predetermined destination of the electric vehicle, available charging capacity of a current charging station comprising the charging point, estimated charging workload at the current charging station, available charging capacity of other charging stations, estimated charging workload at other charging stations, distance to other charging stations.

According to some embodiments, the charging data comprises at least one of the following: an estimated remaining charging time and a make and a model of the electric vehicle being charged.

According to some embodiments, the display element comprises any one of: a display of the charging point, a display board of the charging station, and a display of a mobile device.

According to some embodiments, the additional data comprises at least one of a predetermined destination of the electric vehicle and a predetermined route of the electric vehicle, and output data comprises information concerning and/or related to a recommended next charging station along the predetermined route or along a determined route to the predetermined destination of the electric vehicle.

According to some embodiments, at least a portion of the output data is generated based on estimated operation range of the electric vehicle after ending the charging event.

According to some embodiments, the output data comprises a recommended duration of the ongoing charging event at the current charging point and/or a recommended remaining charging time of the ongoing charging event at the current charging point and the output data further comprises information concerning a recommended next charging station within the operation range of the electric vehicle after the ongoing charging event is ended as recommended by means of the output data.

According to some embodiments, the recommended duration of the ongoing charging event and/or the recommended remaining charging time of the ongoing charging event is shorter than a time required to fully charge the battery of the electric vehicle.

According to an embodiment, a method for information delivery management during a charging event is provided. The method comprises connecting an electric vehicle to a charging point for charging the electric vehicle during a charging event, identifying, by a control unit, an ongoing charging event, receiving, by the control unit, charging event data related to at least one of the charging event and the electric vehicle being charged during the charging event, and receiving at least one piece of additional data. The method further comprises generating, by the control unit, output data based on at least the charging event data and the additional data received, and displaying on the display element the output data during the charging event.

According to some embodiments, the method comprises using, by the control unit, at least the charging event data and the additional data as parameters, and comparing, by the control unit, these parameters to predetermined conditions when generating the output data.

According to some embodiments, the additional data comprises at least one of a predetermined destination of the electric vehicle and a predetermined route of the electric vehicle, and the method comprises generating, by the control unit, output data on basis of at least the predetermined route or a determined route to the predetermined destination of the electric vehicle, the output data comprising information concerning and/or related to a recommended next charging station along the predetermined route or along the determined route to the predetermined destination of the electric vehicle.

According to some embodiments, the method comprises generating, by the control unit, the output data based on estimated operation range of the electric vehicle after ending the charging event.

According to some embodiments, the method comprises generating, by the control unit, output data comprising a recommended duration of the ongoing charging event and/or a recommended remaining charging time of the ongoing charging event and the output data further comprising information concerning a recommended next charging station within the estimated operation range of the electric vehicle after the ongoing charging event is ended as recommended by means of the output data.

According to some embodiments, the recommended duration of the ongoing charging and/or the recommended remaining charging time of the ongoing charging event is shorter than a time required to fully charge the battery of the electric vehicle.

According to some embodiments, a computer program product stored in a computer readable media is provided. The computer program product is configured to, when executed by a computer or computer system, perform the method according to any one of the above aspects.

According to a further embodiment, a computer readable medium is provided having stored therein computer program product configured to, when executed by a computer of a computer system, perform the method according to any one of the above aspects.

An advantage of the method and arrangement of the disclosure is that relevant data is delivered for the end user at a relevant time during the charging event. Further, charging working load by a network of associated charging stations can be balanced.

### BRIEF DESCRIPTION OF THE DRAWINGS

In the following the disclosure will be described in greater detail by means of preferred embodiments with reference to the accompanying drawings, in which

FIG. 1 illustrates schematically an arrangement for data management during a charging event; and

FIG. 2 illustrates a method for data management during a charging event.

FIG. 3 illustrates an exemplary method for generating output data.

### DETAILED DESCRIPTION OF THE DISCLOSURE

Providing data relevant for the end user in a given situation at a given time can be highly useful for many purposes, such as to offer a mutually beneficial option regarding for instance charging parameters or targeted marketing communication for the end user.

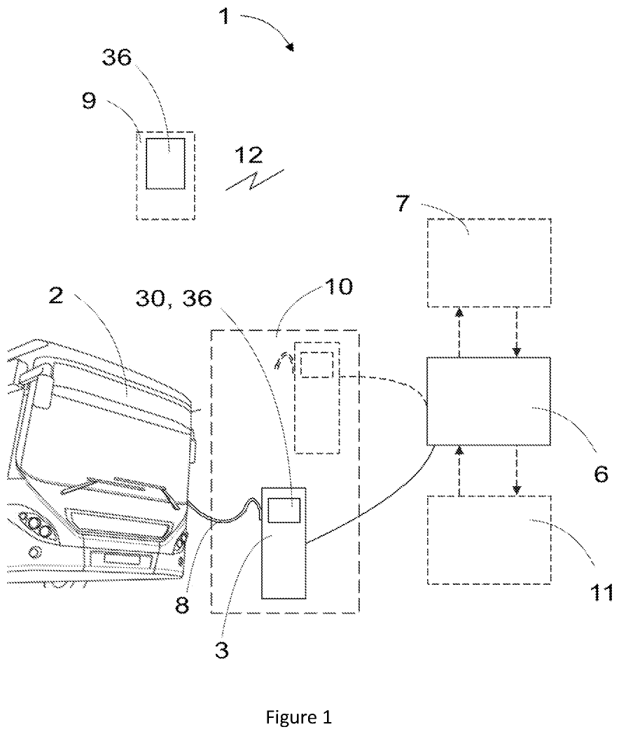

FIG. 1 illustrates schematically an arrangement for data management during a charging event.

A charging event starts, when an electric vehicle 2 arrives at a charging station 10 to a charging point 3 that is available. The charging station 10 may comprise one or more charging points 3. According to an embodiment, the charging station 10 may comprise two or more charging points 3. The charging point 3 being available, or free, refers to the charging point not being busy, in other words not being connected to another electric vehicle at that moment.

After the electric vehicle 2 has arrived at the charging station 10, the charging event continues by the electric vehicle 2 being connected to the charging point 3 by a charging connector. According to an embodiment, an end user, such as the driver of the electronic vehicle 2, may connect the electric vehicle 2 to the charging point 3 by a charging cable 8. Typically, at least one plug is provided in the at least one end of the charging cable 8 for connecting the cable to a socket provided in the electric vehicle 2 and/or the charging point 3. Depending on the embodiment, the charging cable may be attached fixedly to the charging point 3 at its first end and comprise a charging connector, also known as plug, to be attached to a charging connector socket of the electric vehicle 2, or the charging cable 8 may comprise a charging connector, also known as plug, at both of its ends, wherein one of the charging connectors is configured to be attached to a charging connector, also known as socket, of the electric vehicle 2 and the other to a charging connector, also known as socket, of the charging point 3. According to a further embodiment, the electric vehicle 2 may be connected to the charging point 3 to receive electric power from the charging point 3, 4 in another manner than by a charging cable 8. For example, wireless charging may be provided as known in the art. Connecting an electric vehicle 2 to a charging point 3 is widely known in the art and is, thus, not defined here in more detail.

According to an embodiment, the charging point 3 may comprise a display element 36. At the start of the charging event, before the electric vehicle is connected to the charging point 3, the display element 36 may be configured to prompt the end user to connect the electric vehicle 2 to the charging point 3, for instance by connecting the charging cable 8 to the electric vehicle 2 via a charging connector. If all the charging points 3 are already taken, in other words connected to other electric vehicles 2, a control unit 6 of an arrangement 1 for data management of the charging station may be configured to retrieve data about the next available charging point 3. This data may be retrieved from a memory 11 or from the charging points 3 in real time. The memory 11 may comprise a memory of the arrangement 1 for data management, a memory of the control unit 6, the memories of the charging points 3 or other memory 11 connected to the arrangement 1. The data about the next available charging point 3 and a time the charging point 3 is estimated to be available may be generated on the basis of charging states and charging power of the ongoing charging events. The display element 36 may be configured to prompt the end user the next available charging point 3 and the time the charging point 3 will be available.

An arrangement 1 for data management during a charging event, such as the arrangement of FIG. 1, may comprise at least one charging point 3 configured to be connected to one electric vehicle 2 at a time for charging the electric vehicle during a charging event, a display element 36, and at least one control unit 6. The control unit 6 may be configured to identify an ongoing charging event. The control unit 6 may further be configured to receive charging event data related to at least one of the charging event and the electric vehicle 2 being charged during the charging event, and to further receive at least one piece of additional data.

The charging event ends when the charging connector 3 is disconnected from the electric vehicle 2 and the charging cable 8 and the charging connector 3 are returned to their idle position at the charging point 3. The electric vehicle 2 then leaves the charging point 3 and the charging station 10.

According to an embodiment, the charging data may comprise at least one of the following: an estimated remaining charging time and a make and a model of the electric vehicle being charged.

According to an embodiment, the control unit 6 and/or the charging point 3 connected to an electric vehicle to be or being charged with electric power may be configured to identify the electric vehicle 2, and more particularly at least a make, also referred to as a brand, and/or model of the electric vehicle 2 automatically, and the make and/or model of the electric vehicle 2 is received in the control unit 6. According to some embodiments, the electric vehicle is identified as disclosed in the Finnish patent application FI 20216007. According to another embodiment, the control unit 6 receives the make and/or model of the electric vehicle 2 from a user interface 30 of the arrangement 1 for data management in response to the end user determining and entering the make and/or model of the electric vehicle 2 via the user interface 30.

According to an embodiment, the additional data may comprises at least one of the following: an estimated duration of the charging event, a location of the charging point 3, a location of the charging point 3 in relation to a service provider, a distance of the charging point 3 to a service provider, time, date, day of the week, time of the year, weather information, road weather, road traffic congestion data, predetermined destination of the electric vehicle 2, predetermined route of the electric vehicle 2, remaining distance to the predetermined destination of the vehicle 2.

According to an embodiment, the charging data, the additional data and/or a part thereof is retrieved from the memory 11, from an external system 7 and/or from the electric vehicle 2. According to an embodiment, additional data may be received from the electric vehicle 2 via the charging cable 8, via a wireless connection (not shown) or in some other manner.

The control unit 6 may further be configured to generate output data based on at least the charging event data and the additional data received and to display the output data on the display element 36 during the charging event. According to an embodiment, the control unit 6 may be configured to additionally retrieve further data, such as data from an internal marketing database, stored in the memory 11 or further data, such as data from an external marketing recommendation engine, from an external system 7 and combine the further data with the charging data and the additional data for generating the output data. Preferably, the output data generated and displayed during the charging event is not displayed any more after the charging event ends, but a new output data is generated for each new charging event based on respective parameters.

According to an embodiment, the output data may comprise information about services provided by service providers located within a walking distance from the charging point 3. According to an embodiment, the control unit 6 may be configured to use at least the charging data and the additional data as parameters when generating the output data. In other words, the control unit 6 may be configured to compare these parameters to predetermined conditions when generating the output data.

According to an embodiment, this information about services may comprise information about products or services of a cafeteria or restaurant. According to an embodiment the information about products or services of a cafeteria or restaurant may further be determined by an estimated duration or remaining duration of the charging event and the time of day, such as a lunch time used as parameters. For example, if the estimated remaining duration of the charging event is at least 20 minutes, 30 minutes or some other predetermined duration and it is lunch time, the control unit 6 may be configured to generate output information comprising information about lunch time services, such as lunch advertisements, of a nearby cafeteria or restaurant, but not to generate this type of output information if one or both of the parameters are not fulfilled.

According to an embodiment, the output data may comprise marketing communications and/or at least one advertisement.

According to an embodiment, the additional information comprises information on a predetermined route of the identified electric vehicle 2, and the control unit 6 is configured to generate output information comprising information concerning or related to the remaining portion of the predetermined route of the electric vehicle 2. The additional information may alternatively or additionally comprise information on a predetermined destination of the electric vehicle 2. Based on location of the charging station 10 and the predetermined destination, a recommended route may be determined for the electric vehicle 2. Based on the predetermined route or the determined route, output information may be generated that concerns or is related to the next recommended charging station of the electric vehicle. The output information may comprise information on services available along the remaining portion of the predetermined route, such as information related to a recommended next charging station 10 of the electric vehicle 2 after completion of the current charging event. According to an embodiment, the output information comprises information concerning the recommended next charging station along the remaining portion of the predetermined route or the determined route, which may be selected by the control unit 6 by combining electric vehicle identity information and various pieces of additional information such as expected operation range of the electric vehicle 2 after completing the charging event, which may further depend on other pieces of additional information such as weather and/or traffic conditions as well as predicted availability of a free charging point 3 at the next recommended charging station 10. For example, if it is predicted that a certain charging station 10 along the remaining route is very busy when the electric vehicle 2 is expected to arrive, an alternative charging station 10 may be recommended. This helps in balancing charging workload between charging stations by facilitating more even distribution of electric vehicles between charging stations. According to an embodiment, the output information concerning the recommended next charging station further comprises information on services available at or near the recommended next charging station 10. This information may also comprise marketing information and opening hours of services.

An example of recommending next charging station provided during a charging event may indicate that by charging the vehicle now for just 15 minutes instead of waiting the battery of the electric vehicle to be full in 1 hour, there will be sufficient charge for reaching the next charging station at charging station X. In this context, the singular form “battery” of the electric vehicle refers to one or more batteries of the electric vehicle. Based on additional data, it can be determined by the control unit 6 that there is no rush expected at the charging station X upon arrival of the electric vehicle, and there are further services Y and Z available. Further, a discount coupon may be provided to the user for a service at or near the recommended next charging station, for example for a lunch offer available nearby the recommended next charging station during the longer charging period at the recommended next charging station. In the above example, the current charging point of the current, busy charging station becomes available significantly earlier to another electric vehicle, if the driver follows the instructions given through the displayed information, while guiding the driver to spend longer time at the recommended next charging station which is not as busy. The displayed output information can be partially commercial, but the output information also improves charging workload balancing between different charging stations while ensuring that the recommended course of action can be performed, taking into account the technical characteristics and capabilities of the electric vehicle as well as many other constraints and parameters determining operation range of the electric vehicle and availability and capacity of charging services as well as other complementary services. Thus, the possibly limited capacity of a charging station network is better utilized.

According to an embodiment, the display element 36 may comprise at least one of the following: a display of the charging point 3, a display board of the charging station 10 and a display of a mobile device.

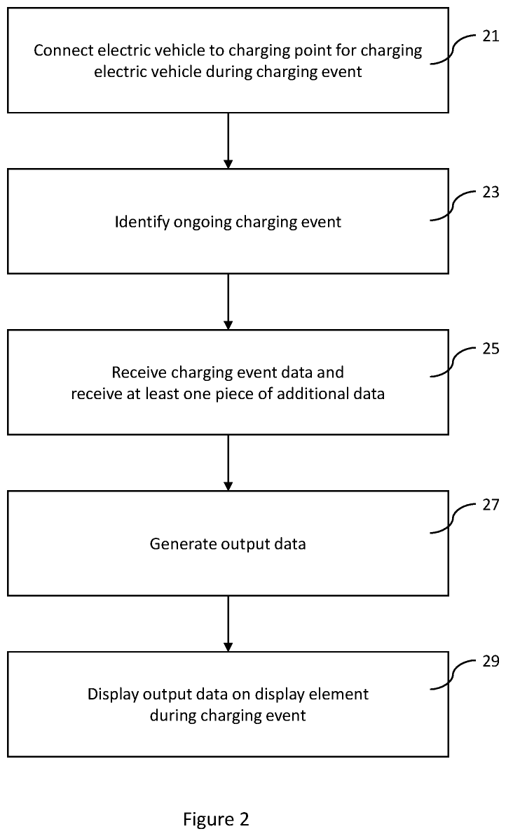

FIG. 2 illustrates a method for data management during a charging event.

A method for data management during a charging event, such as the method of FIG. 2, may comprise connecting 21 an electric vehicle 2 to a charging point 3 for charging the electric vehicle during a charging event, and identifying 23, by a control unit 6, an ongoing charging event. The method may further comprise receiving, by the control unit 6, charging event data related to at least one of the charging event and the electric vehicle 2 being charged during the charging event, and further receiving at least one piece of an additional data, and generating, by the control unit 6 output data based on at least the charging event data and the received additional data. The method may then comprise displaying on the display element 36 the output data during the charging event.

According to an embodiment, the display element may comprise a display element 36 of the charging point 3. This may be particularly beneficial, as the end user's attention typically is naturally in the charging point display especially when the charging event is initiated, and as the data can be tailored to that particular charging event and for that particular end user. According to another embodiment, the display element 36 may comprise a display board or a predetermined part of the display board provided at the charging station 10. This may be beneficial if, for example, the charging point 3 has no display element of its own.

According to an embodiment, the display element 36 of the charging point 3 or of the charging station 10 may display a QR code or other machine-readable code. The end user may read the QR code with his/her own mobile device 9, which provides a wireless link 12 to a web site or to an application running on the end user's mobile device. This may enable the end user to receive information concerning the charging event and at least a portion of the generated output information on his/her own mobile device 9, either by visiting a web site linked by the QR code or other machine-readable code or by using an application running on the end user's mobile device 9, activated automatically by reading the QR code or other machine-readable code.

According to an embodiment, the control system generates a QR code or other machine-readable code or a visually readable identifier to be displayed by the display element 36 in the end user's mobile device 9. The QR code or other machine-readable code or the visually readable identifier may be used as a coupon for receiving a service from a service provider during the charging event or during a next recommended charging event as indicated by the output information. By means of charging point specific or charging station specific QR codes or other machine-readable codes, it is also possible to gather valuable information concerning reach and effectivity of communication displayed by the display element 36.

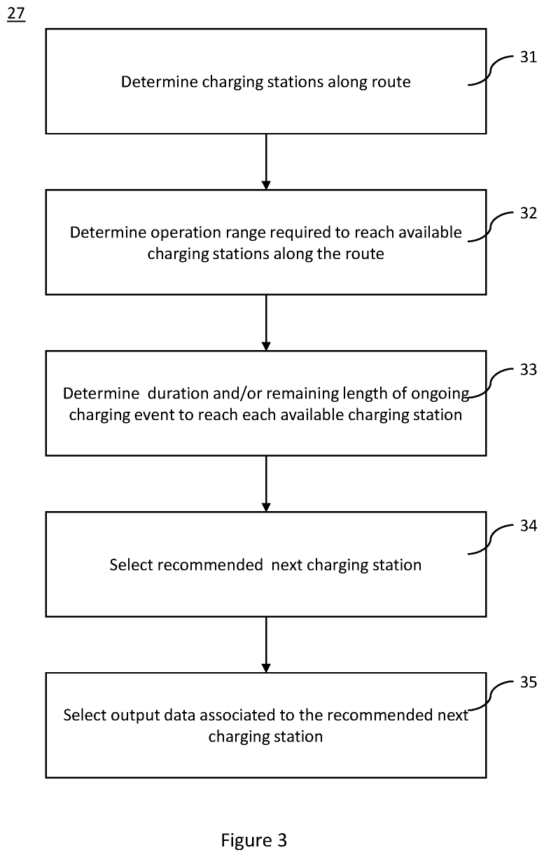

FIG. 3 discloses in more detail an example of generation of output data in the step 27, when additional information comprise information concerning a predefined destination or a predefined route of the electric vehicle. If the predefined destination is known, a route from the current charging station to the predefined destination can be determined using well-known computer implemented navigation and route planning methods, which may take into account various additional parameters such as weather conditions, road conditions, traffic conditions and so forth. Available charging stations along the determined or predetermined route are identified in the step 31 and required operation range of the electric vehicle to each of these can be determined in the step 32. Based on charging event information, capabilities of the electric vehicle can be obtained, and operation range of the electric vehicle can be determined on different battery charging levels. Based on required operation ranges to available charging stations along the planned route, a required charge level of the battery of the electric vehicle to reach each available charging station can be determined. Based on charging event information, it can be determined in the step 33 how long the ongoing charging event should be and/or continue to charge the battery of the electric vehicle to a level that provides sufficient operating range to reach any one of the available charging stations along the planned route. Further additional information related to available charging stations may be utilized as further parameters in the step 34 to select a recommended next charging station. For example, the additional information may comprise information on services and/or opening hours of services available at different available charging stations, date, time of day, expected rush hours and more. Output data is selected in the step 35 based on combination of all used parameters. When the recommended next charging station does not require the battery to be fully charged at the ongoing charging event, output data preferably comprises information on recommended duration of the ongoing charging event and/or recommended remaining charging time of the ongoing charging event, as well as identification and/or location of the recommended next charging station. The displayed data may show a timer counting down towards the recommended end of the ongoing charging event, even when the recommended end occurs before the battery are fully charged. The output data may further comprise information concerning additional services available at or near the recommended next charging station, and the output data may further comprise commercial information concerning such additional services to further motivate the end user to end the ongoing charging event early before the battery is fully charged.

As used herein, a computer refers to any electronic device comprising a processor, such as a general-purpose central processing unit (CPU), a specific purpose processor or a microcontroller. A computer is capable of receiving data (an input), of performing a sequence of predetermined operations thereupon, and of producing thereby a result in the form of information or signals (an output). Depending on context, the term “computer” will mean either a processor in particular or can refer more generally to a processor in association with an assembly of interrelated elements contained within a single case or housing.

As used herein, a mobile device can be any type of portable electronic device, such as a cellular telephone, a Personal Digital Assistant (PDA), smartphone, tablet etc. The mobile device preferably comprises a display and at least one input/output (I/O) component.

The systems and methods described herein may be embodied by a computer program or a plurality of computer programs, which may exist in a variety of forms, both active and inactive, in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

As used herein, a computer-readable medium or storage medium can be any means that can contain, store, communicate, propagate, or transport a program for use by or in connection with the computer program execution system, apparatus or device. The computer readable medium can be, for example but not limited to, an electronic, magnetic, optical, electromagnetic, infrared, or semiconductor system, apparatus, device, or propagation medium. A non-exhaustive list of more specific examples of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM) or like.

The embodiments disclosed provide both sellers and charging station operators a possibility to provide targeted information, such as charging service-related information and/or marketing information to the end users, which is beneficial for both the end users and the sellers. This may be particularly beneficial as the charging events typically take a longer time than filling the fuel tank. The embodiments enable charging workload balancing between charging stations by guiding end users to less busy charging stations, for example by shortening charging event durations on a very busy charging station and instructing end 10 users to have their longer charging events at less busy charging stations. It may also create a new business opportunity for the charging station operators, as it is difficult to achieve high margins from the charging service itself.

1. An information delivery arrangement for data management during a charging event, the information delivery arrangement comprising:
at least one charging point configured to be connected to one electric vehicle at a time for charging the electric vehicle during a charging event,
a display element, and
at least one control unit, the at least one control unit configured
to identify an ongoing charging event,
to receive charging event data related to at least one of the charging event and the electric vehicle being charged during the charging event, and
to receive at least one piece of addition data,
to generate output data based on at least the charging event data and the received additional data, and
to display the output data on the display element during the charging event.

2. The information delivery arrangement according to claim 1, wherein the control unit is configured to use at least the charging event data and the additional data as parameters when generating the output data by comparing these parameters to predetermined conditions.

3. The information delivery arrangement according to claim 1, wherein the additional data comprises at least one of the following: an estimated duration of the charging event, a location of the charging point, a location of the charging point in relation to a service provider, a distance of the charging point to a service provider, time, date, day of the week, time of the year, weather information, road weather, road traffic congestion data, predetermined destination of the electric vehicle, predetermined route of the electric vehicle, remaining distance to the predetermined destination of the electric vehicle, available charging capacity of a current charging station comprising the charging point, estimated charging workload at the current charging station, available charging capacity of other charging stations, estimated charging workload at other charging stations, and/or distance to other charging stations.

4. The information delivery arrangement according to claim 1, wherein the charging data comprises at least one of the following: an estimated remaining charging time and/or a make and a model of the electric vehicle being charged.

5. The information delivery arrangement according to claim 1, wherein the display element comprises any one of: a display of the charging point, a display board of the charging station, and/or a display of a mobile device.

6. The information delivery arrangement according to claim 1, wherein the additional data comprises at least one of a predetermined destination of the electric vehicle and/or a predetermined route of the electric vehicle (2), and wherein the output data comprises information concerning and/or related to a recommended next charging station along the predetermined route or along a determined route to the predetermined destination of the electric vehicle.

7. The information delivery arrangement according to claim 6, wherein at least a portion of the output data is generated based on an estimated operation range of the electric vehicle after ending the charging event.

8. The information delivery arrangement according to claim 6, wherein the output data comprises a recommended duration of the ongoing charging event at the current charging point and/or a recommended remaining charging time of the ongoing charging event at the current charging point; and wherein the output data further comprises information concerning a recommended next charging station within the estimated operation range of the electric vehicle after the ongoing charging event is ended as recommended by means of the output data.

9. The information delivery arrangement according to claim 8, wherein the recommended duration of the ongoing charging event and/or the recommended remaining charging time of the ongoing charging event is shorter than a time required to fully charge the battery of the electric vehicle.

10. A method for information delivery management during a charging event, the method comprising:
connecting an electric vehicle to a charging point for charging the electric vehicle during a charging event,
identifying, by a control unit, on ongoing charging event,
receiving, by the control unit, charging event data related to at least one of the charging event and the electric vehicle being charged during the charging event,
receiving at least one piece of additional data,
generating, by the control unit, outpost data based on at least the charging event data and the additional data received, and
displaying on a display element the output date during the charging event.

11. The method according to claim 10, comprising
using, by the control unit, at least the charging event data and the additional data parameters, and
comparing, by the control unit, these parameters to be predetermine conditions when generating the output data.

12. The method according to claim 10, wherein the additional data comprises at least one of the following: an estimated duration of the charging event, a location of the charging point, a location of the charging point in relation to a service provider, a distance of the charging point to a service provider, time, date, day of the week, time of the year, weather information, road weather, road traffic congestion data, predetermined destination of the electric vehicle, predetermined route of the electric vehicle, remaining distance to the predetermined destination of the electric vehicle, available charging capacity of a current charging station comprising the charging point, estimated charging workload at the current charging station, available charging capacity of other charging stations, estimated charging workload at other charging stations, and/or distance to other charging stations.

13. The method according to claim 10, wherein the charging data comprises at least one of the following: an estimated remaining charging time and/or a make and a model of the electric vehicle being charged.

14. The method according to claim 10, wherein the display element comprises any one of: a display of the charging point, a display board of the charging station, and a display of a mobile device.

15. The method according to claim 10, wherein the additional data comprises at least one of a predetermined destination of the electric vehicle and/or a predetermined route of the electric vehicle, and wherein the method further comprises:
generating, by the control unit, output data on basis of at least the predetermined route or a determined route to the predetermined destination of the electric vehicle, and wherein the output data comprises information concerning and/or related to a recommended next charging station along the predetermined route or along the determined route to the predetermined destination of the electric vehicle.

16. The method according to claim 15, comprising:
generating, by the control unit, the output data based on an estimated operation range of the electric vehicle after ending the charging event.

17. The method according to claim 16, comprising:
generating, by the control unit, output data comprising a recommended duration of the ongoing charging event and/or a recommended remaining charging time of the ongoing charging event; and wherein the output data further comprises information concerning a recommended next charging station within the estimated operation range of the electric vehicle after the ongoing charging event is ended as recommended by means of the output data.

18. The method according to claim 17, wherein the recommended duration of the ongoing charging and/or the recommended remaining charging time of the ongoing charging event is shorter than a time required to fully charge the battery of the electric vehicle.

19. A computer program product stored in a computer readable media and configured to, when executed by a computer or computer system, perform the method according to claim 10.
